(19) United States
(12) Patent Application Publication
(10) Pub. No.: US 2009/0248847 A1
(43) Pub. Date: Oct. 1, 2009

(54) STORAGE SYSTEM AND VOLUME MANAGING METHOD FOR STORAGE SYSTEM

(76) Inventors: Atsushi SUTOH, Yokohama (JP); Hitoshi KAMEI, Sagamihara (JP)

Correspondence Address: MATTINGLY & MALUR, P.C., 1800 DIAGONAL ROAD, SUITE 370, ALEXANDRIA, VA, 22314, US

(21) Appl. No.: 12/122,072

(22) Filed: May 16, 2008

(30) Foreign Application Priority Data
Mar. 26, 2008 (JP) 2008-082030

(51) Int. Cl. G06F 12/00; G06F 15/173; G06F 17/30

(52) U.S. Cl. 709/223; 707/200; 707/E17.005

(57) ABSTRACT

A time and an amount of data for setting information which is necessary to execute an exclusion process which is necessary when data is stored in a cluster system are reduced. A storage system included in the cluster system includes a plurality of volumes, and a plurality of virtual servers utilizing at least one or more volumes of the plurality of volumes for a data processing, each of the plurality of virtual servers can access all the plurality of volumes, and the volume utilized by the plurality of virtual servers to process data corresponds to the virtual servers.

### CROSS-REFERENCES TO RELATED APPLICATIONS

This application relates to and claims priority from Japanese Patent Application No. 2008-082030, filed on Mar. 26, 2008, the entire disclosure of which is incorporated herein by reference.

### BACKGROUND

1. Field of the Invention

The present invention relates to a storage system and a volume managing method of the storage system, particularly, is preferable to be applied to the storage system and the volume managing method of the storage system which manage a volume in a cluster system operating a virtual server.

2. Description of Related Art

A cluster-base synchronization process is executed among nodes included in a cluster. Conventionally, it is necessary to synchronize databases among all the nodes included in the cluster when changing a setting of a service.

That is, under such a cluster circumstance that a virtual file server function is used, it has been necessary to store setting information which is necessary to initiate the virtual file server in the CDB (Cluster Data Base) included in a cluster managing function, and in a shared LU (Logical Unit) to which every node can refer. By synchronizing the CDB and the shared LU as described above, it is possible to execute an exclusion process for causing the processes not to collide among the nodes.

Meanwhile, the setting information includes, for example, a system LU storing an OS (Operating System) which is necessary to initiate the virtual file server, the LU which is usable by each virtual file server, a network interface, an IP (Internet Protocol) address, and the like.

These techniques mentioned above are disclosed in the Linux Failsafe Administrator's Guide FIG. 1-4(P.30), “HYPERLINKhttp://oss.sgi.com/projects/failsafe/docs/LnxFailSafe_AG/pdf/LnxFailSafe_AG.pdf” and in the SGI-Developer_Central_Open_Source_Linux_FailSafe.pdf, “http://oss.sgi.com/projects/failsafe/doc0. html”.

### SUMMARY

In the above conventional technique, it is necessary to provide the CDB in every node, and to synchronize information stored in each CDB when the setting information is changed. However, since it is necessary to execute such a synchronization process, when the service is changed, the virtual file server can not execute a process for changing another service until the synchronization process for the changed content is completed. Thus, under the cluster circumstance, as the number of nodes becomes larger, it takes a longer time for the synchronization process, and it takes a longer time until another process can be started. In the above conventional technique, when the service is changed, it is also necessary to execute the synchronization process for another CDB which does not relate to the setting change because of the changed service. Thus, under the cluster circumstance, it is preferable to reduce information synchronized among the nodes as much as possible.

The present invention has been invented in consideration of the above points, and object of the present invention is to propose the storage system and the volume managing method of the storage system which reduces a time and a data quantity for setting information which is necessary to execute the exclusion process which is necessary when data is stored in the cluster system.

The present invention relates to a storage system included in the cluster system, the storage system including a plurality of volumes, and a plurality of virtual servers utilizing at least one or more volumes of the plurality of volumes for a data processing, each of the plurality of virtual servers can access all of the plurality of volumes, and the volume utilized by the plurality of virtual servers for the data processing includes a storing unit for storing information indicating that the volume corresponds to the virtual server.

According to the present invention, the storage system and the volume managing method of the storage system can be proposed, which reduces a time and a data quantity for setting information which is necessary to execute the exclusion process which is necessary when data is stored in the cluster system.

Other aspects and advantages of the invention will be apparent from the following description and the appended claims.

### BRIEF DESCRIPTION OF THE DRAWINGS

FIG. 1 is a block diagram illustrating a physical configuration of a storage system according to a first embodiment of the present invention.

FIG. 2 is a diagram illustrating a logical configuration of the storage system according to the first embodiment.

FIG. 3 is a block diagram illustrating a configuration of a NAS server software module according to the first embodiment.

FIG. 4 is a diagram illustrating a cluster configuration node table according to the first embodiment.

FIG. 5 is a diagram illustrating a disk drive table according to the first embodiment.

FIG. 6 is a diagram illustrating a virtual NAS information table according to the first embodiment.

FIG. 7 is a diagram illustrating a LU storing information table according to the first embodiment.

FIG. 8 is a flowchart illustrating a process when executing a node initiating program according to the first embodiment.

FIG. 9 is a flowchart illustrating a process when executing a node stopping program according to the first embodiment.

FIG. 10 is a flowchart illustrating a process when executing a disk setting reflecting program according to the first embodiment.

FIG. 11 is a flowchart illustrating a process when executing a disk setting analyzing program according to the first embodiment.

FIG. 12 is a flowchart illustrating a process when executing a virtual NAS generating program according to the first embodiment.

FIG. 13 is a flowchart illustrating a process when executing a virtual NAS deleting program according to the first embodiment.

FIG. 14 is a flowchart illustrating a process when executing a virtual NAS initiating program according to the first embodiment.

FIG. 15 is a flowchart illustrating a process when executing a virtual NAS stopping program according to the first embodiment.

FIG. 16 is a flowchart illustrating a process when executing a virtual NAS setting program according to the first embodiment.

FIG. 17 is a flowchart illustrating a process when executing an another node request executing program according to the first embodiment.

FIG. 18 is a flowchart illustrating a process when executing a virtual NAS operating node changing program according to the first embodiment.

FIG. 19 is a diagram describing operations of the storage system according to the first embodiment.

### DETAILED DESCRIPTION OF PREFERRED EMBODIMENTS

Each embodiment of the present invention will be described below as referring to the drawings. Meanwhile, each embodiment does not limit the present invention.

### First Embodiment

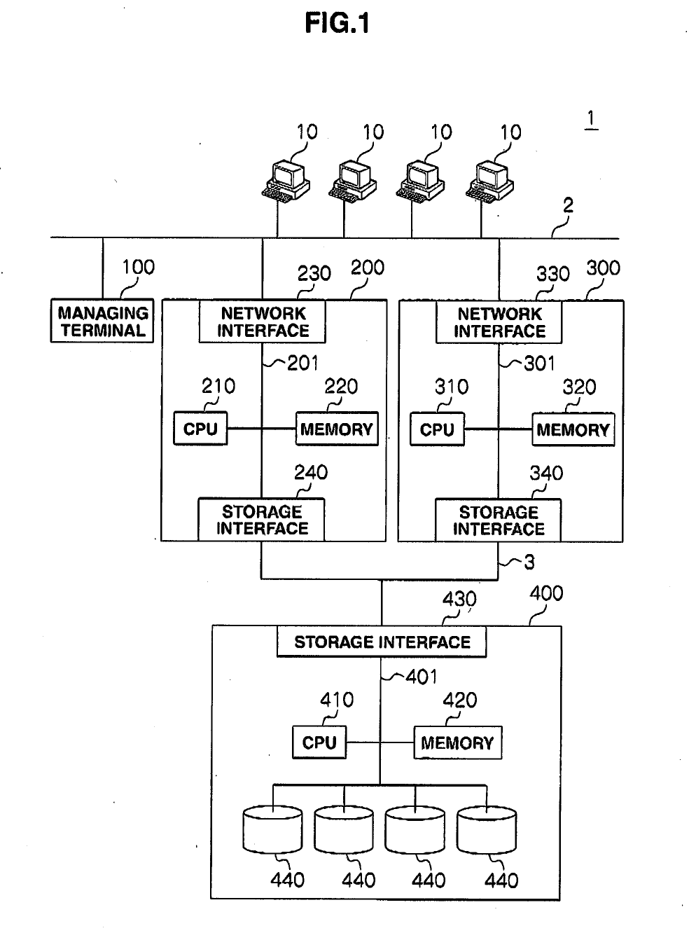

FIG. 1 is a block diagram illustrating a physical configuration of a storage system 1 to which the present invention is applied. As illustrated in FIG. 1, the storage system 1 includes a managing terminal 100, a plurality of NAS clients 10, two NAS servers 200 and 300, a storage apparatus 400. The plurality of NAS clients 10, the managing terminal 100, and the NAS servers 200 and 300 are connected through a network 2, and the NAS servers 200 and 300 and the storage apparatus 400 are connected through a network 3.

Meanwhile, while such a case will be described for a simple description that the storage system 1 includes the two NAS servers 200 and 300, the storage system 1 may be configured so as to include the three or more NAS servers. While such a case will be described that the storage system 1 includes one managing terminal 100, the storage system 1 may be configured so as to include a plurality of the managing terminals 100 managing each of the NAS servers 200 and 300 respectively. While such a case will be described that the storage system 1 includes one storage apparatus 400, the storage system 1 may be configured so as to include the two or more storage apparatus 400.

The NAS client 10 includes an input apparatus such as a keyboard and a display apparatus such as a display. A user operates the input apparatus to connect to an after-mentioned virtual file server (hereinafter, may be referred to as a virtual NAS or a VNAS), and reads data stored in the virtual file server and stores new data in the virtual file server. The display apparatus displays information which becomes necessary when the user executes a variety of jobs.

While the managing terminal 100 includes the input apparatus such as a keyboard and the display apparatus such as a display, since such apparatuses are not directly related to the present invention, the illustration will be omitted. An administrator of the storage system 1 inputs information which is necessary to manage the storage system 1 by using the input apparatus of the managing terminal 100. The display apparatus of the managing terminal 100 displays predetermined information when the administrator inputs the information which is necessary to manage the storage system 1.

The NAS server 200 includes a CPU (Central Processing Unit) 210, a memory 220, a network interface 230, and a storage interface 240. The CPU 210 executes a program stored in the memory 220 to execute a variety of processes. The memory 220 stores the program executed by the CPU 210 and data. The network interface 230 is an interface for communicating data through a plurality of the NAS clients 10, the managing terminal 100, and the network 2. The storage interface 240 is an interface for communicating data through the storage apparatus 400 and the network 3.

The NAS server 300 includes a CPU 310, a memory 320, a network interface 330, and a storage interface 340. The components included in the NAS server 300 are the same as those included in the NAS server 200 excluding the codes, so that the description will be omitted.

The storage apparatus 400 includes a CPU 410, a memory 420, a storage interface 430, and a plurality of disk drives 440. The CPU 410 executes a program stored in the memory 420 to write data in a predetermined location of the plurality of disk drives 440, and to read data from a predetermined location. The memory 420 stores the program executed by the CPU 410 and data. The storage interface 430 is an interface for communicating data through the NAS servers 200 and 300 and the network 3. The plurality of disk drives 440 stores a variety of data.

In a configuration of the storage system 1, the storage apparatus 400 and the NAS servers 200 and 300 are connected through the network 3, and each of the NAS servers 200 and 300 can access the plurality of disk drives 440 of the storage apparatus 400. The NAS servers 200 and 300 can communicate with each other through the network 2. That is, when a service provided to a user of the NAS client 10 is executed, it is necessary to access the disk drive 440 to be used by adjusting the exclusion process between the NAS servers 200 and 300.

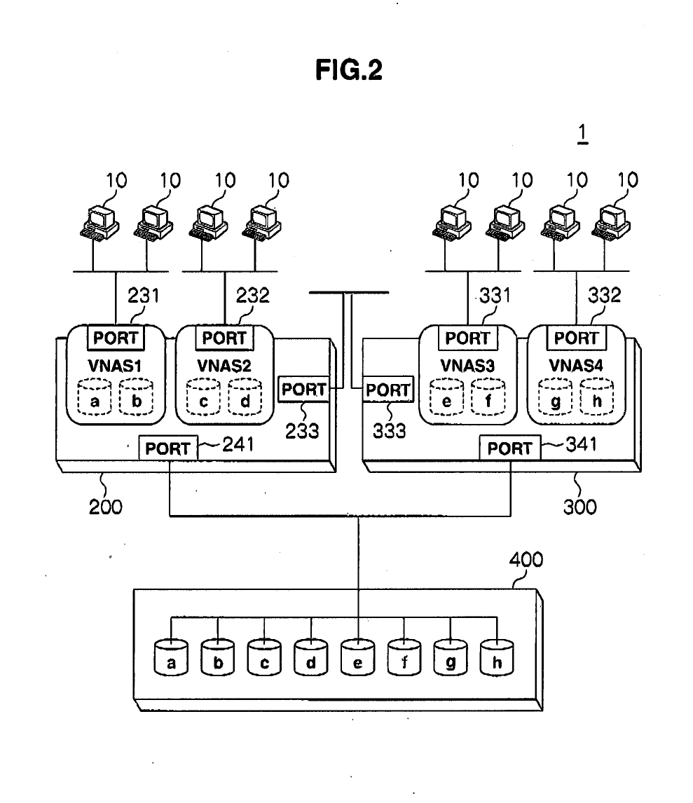

FIG. 2 is a diagram illustrating a logical configuration of the storage system 1. As illustrated in FIG. 2, the NAS server 200 includes a virtual file server VNAS 1 and a virtual file server VNAS 2. The NAS server 300 includes a virtual file server VNAS 3 and a virtual file server VNAS 4. The NAS server 200 and the NAS server 300 can communicate by utilizing a port233 and a port 333. In the storage apparatus 400, volumes a to h are provided. Such volumes a to h are volumes configured with the plurality of disk drives 440.

The virtual file server VNAS 1 connects to the predetermined NAS client 10 through a port 231, and can access the volumes “a” to “h” through a port 241. The virtual file server VNAS 1 includes virtual volumes “a” and “b”. Thus, data write from the predetermined NAS client 10 and data read of the NAS client 10 are executed for the volumes “a” and “b”.

The virtual file server VNAS 2 connects to the predetermined NAS client 10 through a port 232, and can access the volumes “a” to “h” through the port 241. The virtual file server VNAS 2 includes virtual volumes “c” and “d”. Thus, data write from the predetermined NAS client 10 and data read of the NAS client 10 are executed for the volumes “c” and “d”.

The virtual file server VNAS 3 connects to the predetermined NAS client 10 through a port 331, and can access the volumes “a” to “h” through a port 341. The virtual file server VNAS 3 includes virtual volumes “e” and “f”. Thus, data write from the predetermined NAS client 10 and data read of the NAS client 10 are executed for the volumes “e” and “f”.

The virtual file server VNAS 4 connects to the predetermined NAS client 10 through a port 332, and can access the volumes “a” to “h” through the port 341. The virtual file server VNAS 3 includes virtual volumes “g” and “h”. Thus, data write from the predetermined NAS client 10 and data read of the NAS client 10 are executed for the volumes “g” and “h”.

As described above, on the NAS servers 200 and 300, a plurality of the virtual file servers VNAS 1 and 2, and the virtual file servers VNAS 3 and 4 can be executed respectively. Such virtual file servers VNAS 1 to 4 are executed under OSs (Operating System) whose setting are different. Each of such virtual file servers VNAS 1 to 4 independently operates from other file servers.

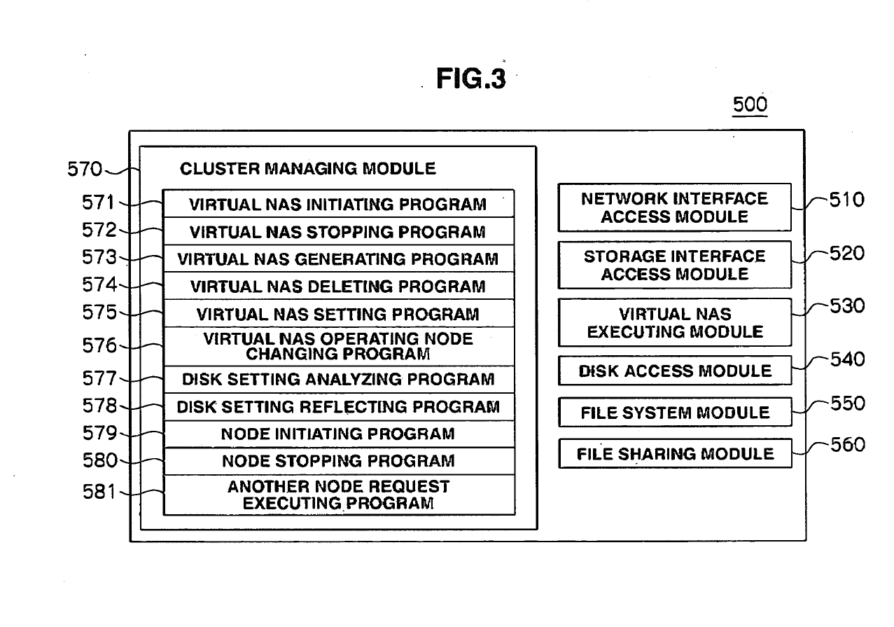

Next, common modules and tables stored in the memories 220 and 320 of the NAS servers 200 and 300 will be described by referring to FIG. 3 to FIG. 6.

FIG. 3 is a block diagram illustrating a configuration of a NAS server software module. This NAS server software module 500 includes a cluster managing module 570, a network interface access module 510, a storage interface access module 520, a virtual NAS executing module 530, a disk access module 540, a file system module 550, and a file sharing module 560.

The network interface access module 510 is a module for communicating with a plurality of the NAS clients 10 and another NAS server. The storage interface access module 520 is a module for accessing the disk drives 440 in the storage apparatus 400. The virtual NAS executing module 530 is a module for executing the virtual file server. The disk access module 540 is a module for accessing the disk drives 440. The file system module 550 is a module for specifying which file of which disk drive. The file sharing module 560 is a module for receiving a request of each file from the NAS client 10.

Thus, when receiving a request from the NAS client 10 the file sharing module 560, the file system module 550, the disk access module 540, the virtual NAS executing module 530, and the storage interface access module 520 are executed, and data is communicated with any one of the volumes “a” to “h” in the storage apparatus 400.

The cluster managing module 570 is a module for executing a process for the virtual file server. The Cluster managing module 570 includes a virtual NAS initiating program 571, a virtual NAS stopping program 572, a virtual NAS generating program 573, a virtual NAS deleting program 574, a virtual NAS setting program 575, a virtual NAS operating node changing program 576, a disk setting analyzing program 577, a disk setting reflecting program 578, a node initiating program 579, a node stopping program 580, an another node request executing program 581.

The virtual NAS initiating program 571 is a program for initiating the virtual NAS file server. The virtual NAS stopping program 572 is a program for stopping the virtual file server. The virtual NAS generating program 573 is a program for generating the virtual file server. The virtual NAS deleting program 574 is a program for deleting the virtual file server. The virtual NAS setting program 575 is a program for setting the virtual file server. The virtual NAS operating node changing program 576 is a program for changing the operating node of the virtual NAS. The disk setting analyzing program 577 is a program for analyzing the disk setting. The disk setting reflecting program 578 is a program for reflecting the disk setting. The node initiating program 579 is a program for initiating the node. The node stopping program 580 is a program for stopping the node. The another node request executing program 581 is a program for executing a request to another node. The detailed processes when such programs are executed by the CPU 210 will be described later

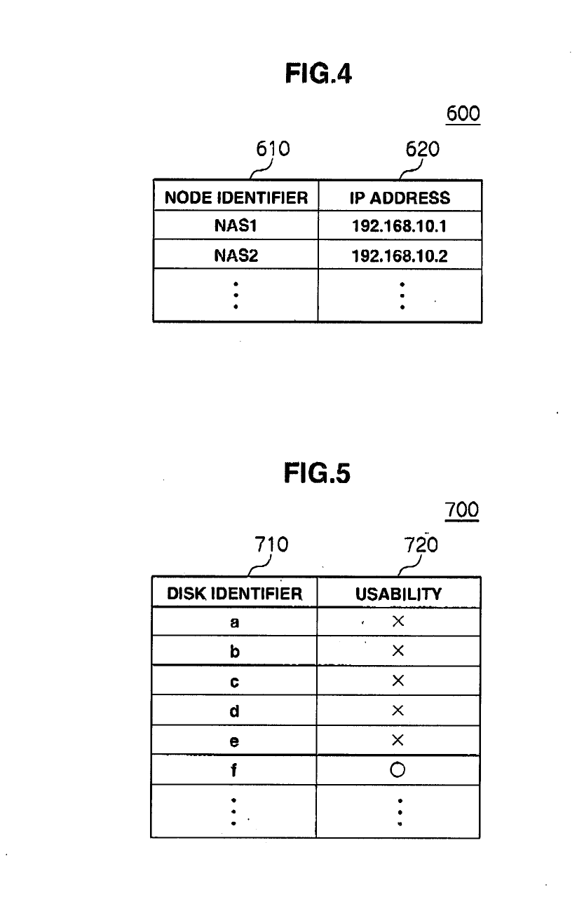

FIG. 4 is a diagram illustrating a cluster configuration node table 600. The cluster configuration node table 600 is a table for storing an ID of the NAS server, and an IP address maintained by the node being executed by the corresponding virtual file server.

The cluster configuration node table 600 includes a node identifier column 610, and a an IP address column 620. The node identifier column 610 stores the identifier of the NAS server. The IP address column 620 stores the IP address maintained by the node.

In the cluster configuration node table 600, for example, “NAS 1” is stored as a node identifier, and “192.168.10.1” is stored as the IP address.

FIG. 5 is a diagram illustrating a disk drive table 700. The disk drive table 700 is a table in which a list of the disk drives 440 of the storage apparatus 400, the disk drives being able to be accessed by the NAS servers 200 and 300, is stored with disk identifiers and usability of the disk drives 440.

The disk drive table 700 includes a disk identifier column 710 and a usability column 720. The disk identifier column 710 stores the disk identifier. The usability column 720 stores information whether or not a disk (volume) indicated by the disk identifier stored in the disk identifier column 710 can be utilized. It is assumed in this first embodiment that, when “X” is stored in the usability column 720, such a condition is indicated that the disk (volume) can not be used, and when “O” is stored, such a condition is indicated that the disk (volume) can be used.

In the disk drive table 700, for example, “a” is stored as the disk identifier, and “X” is stored as the usability of this “a”. That is, information that the volume “a” can not be used is stored.

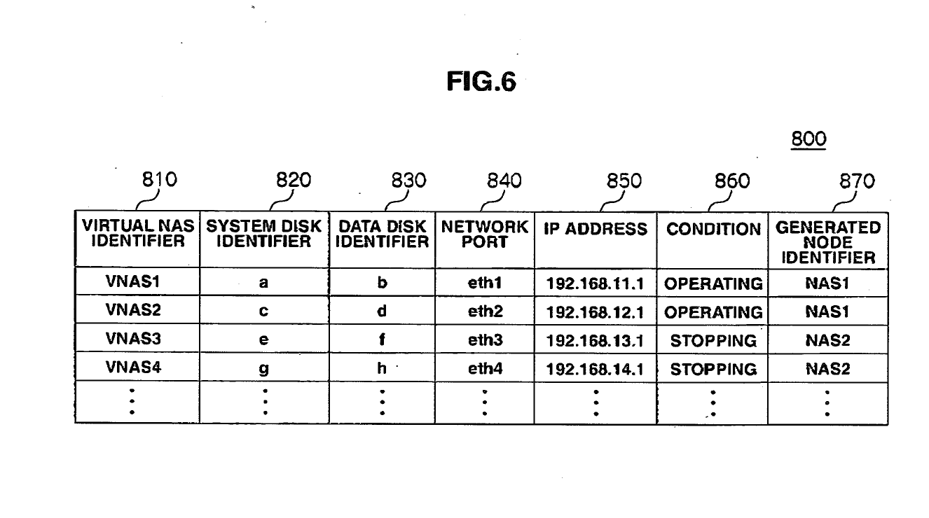

FIG. 6 is a diagram illustrating a virtual NAS information table 800. The virtual NAS information table 800 is a table for storing information on the virtual file server. The virtual NAS information table 800 includes a virtual NAS identifier column 810, a system disk identifier column 820, a data disk identifier column 830, a network port column 840, an IP address column 850, a condition column 860, and a generated node identifier column 870.

The virtual NAS identifier column 810 is a column for storing a virtual NAS identifier (hereinafter, may be referred to as a virtual NAS ID) which is an identifier of the virtual file server. The system disk identifier column 820 is a column for storing an identifier of a disk (volume) which becomes a system disk. The data disk identifier column 830 is a column for storing an identifier of a disk (volume) which becomes a data disk. The network port column 840 is a column for storing a network port. The IP address column 850 is a column for storing the IP address. The condition column 860 is a column for storing information whether the virtual file server is operating or is stopping. The generated node identifier column 870 is a column for storing an identifier of the node in which the virtual file server is generated.

As illustrated in FIG. 6, the virtual NAS information table 800 includes, for example, “VNAS 1” as an identifier of the virtual file server, “a” as a system disk identifier, “b” as a data disk identifier, “eth 1” as the network port, “192.168.11.1” as the IP address, “operating” as condition, and “NAS 1” as a generated node identifier in a series respectively. Meanwhile, “NAS 1” of the generated node identifier column 870 is an identifier for indicating the NAS server 200, and “NAS 2” is an identifier for indicating the NAS server 300.

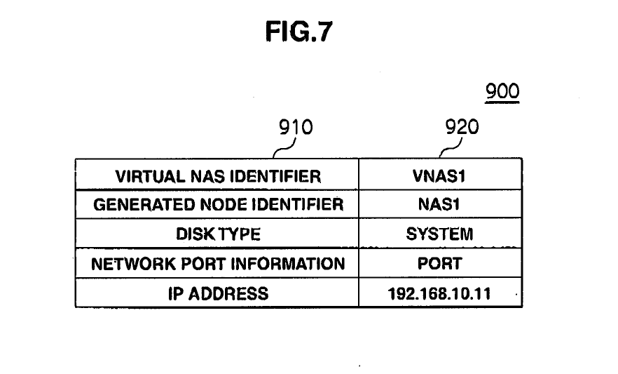

Next, a LU storing information table 900 stored in each of the volumes “a” to “h” will be described. FIG. 7 is a diagram illustrating the LU storing information table 900.

The LU storing information table 900 is a table for storing information on data stored in the volume. The LU storing information table 900 includes an item name column 910 and an information column 920. The item name column 910 includes the virtual NAS identifier column, a generated identifier node column, a disk type column, a network port information column, and the IP address column. The information column 920 stores information corresponding to items set in the item name column 910.

The virtual NAS identifier column stores the virtual NAS identifier for identifying the virtual NAS. The generated identifier node column stores the node of the generated identifier. The disk type column stores a disk type for indicating whether a disk is the system disk or the data disk. The network port information column stores information for indicating the network port. The IP address column stores the IP address.

The LU storing information table 900 stores, for example, “VNAS 1” as the virtual NAS identifier, “NAS 1” as the generated identifier node, “system” as the disk type, “port 1” as network port information, and “192.768.10 11” as the IP address.

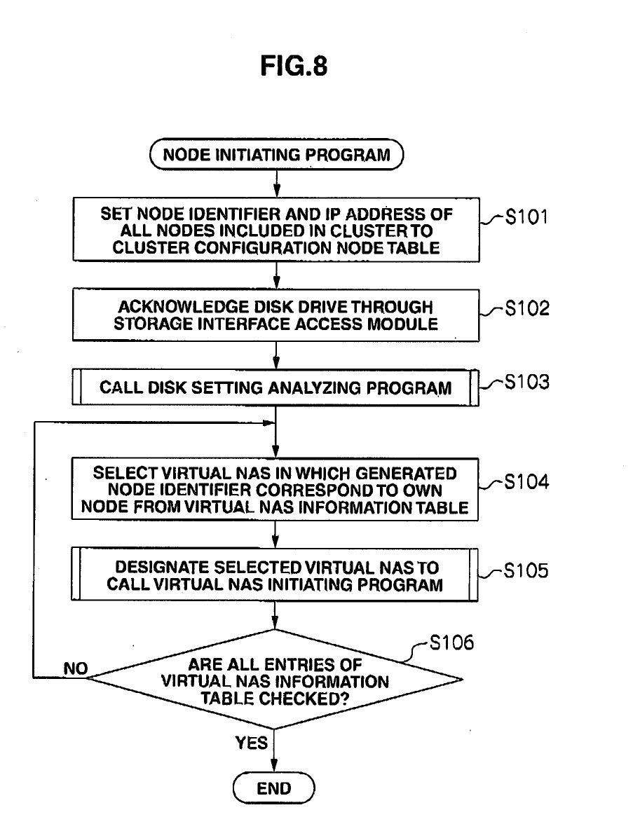

Next, a variety of programs 571 to 581 stored in the cluster managing module 570 will be described by using flowcharts of FIG. 8 to FIG. 18. Processes of such programs are processes executed by the CPU (hereinafter, will be described as processes executed by the CPU 210 of the NAS server 200) of the NAS server.

First, the node initiating program 579 will be described. FIG. 8 is a flowchart illustrating a process when the CPU 210 executes the node initiating program 579.

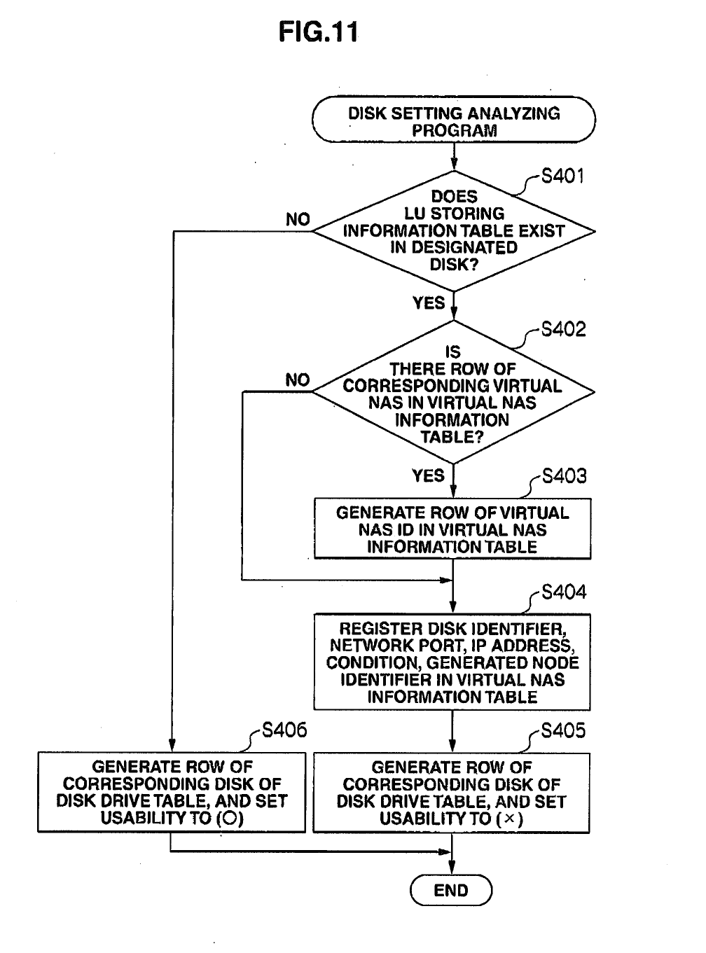

As illustrated in FIG. 8, at step S101, the CPU 210 sets the node identifiers and the IP addresses of all the nodes included in the cluster in the cluster configuration node table 600. At step 8102, the CPU 210 acknowledges the disk drive 440 through the storage interface access module 520. At step S103, the CPU 210 calls the disk setting analyzing program 577. Thereby, a disk setting analyzing process is executed. This disk setting analyzing process will be described later by using FIG. 11.

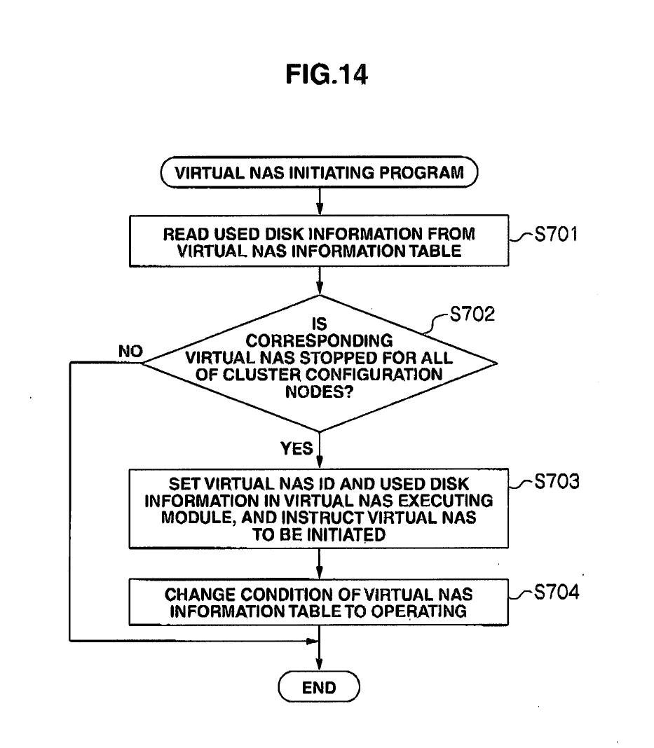

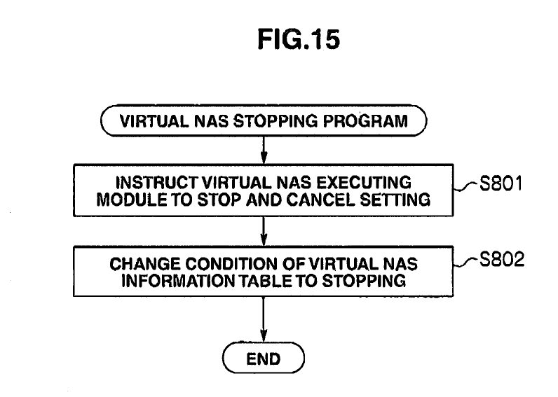

At step S104, the CPU 210 selects the virtual NAS in which the generated node identifier corresponds to the own node from the virtual NAS information table 800. At step S105, the CPU 210 designates the selected virtual NAS to call the virtual NAS initiating program 571. Thereby, a virtual NAS initiating process is executed. This virtual NAS initiating process will be described later by referring to FIG. 14.

At step S106, the CPU 210 determines whether or not all entries of the virtual NAS information table 800 have been checked. When determining that all entries have not been checked (S106: NO), the CPU 210 repeats the processes of steps S104 and S105. On the other hand, when determining that all entries have been checked (S106: YES), the CPU 210 completes this process.

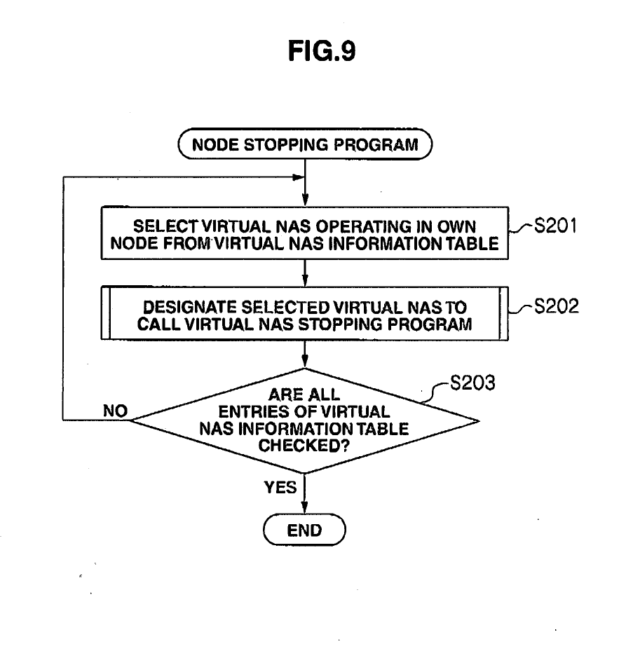

Next, the node stopping program 580 will be described. FIG. 9 is a flowchart illustrating a process when the CPU 210 executes the node stopping program 580.

As illustrated in FIG. 9, at step S201, the CPU 210 selects the virtual NAS which is operating in the own node from the virtual NAS information table 800. At step S201, the CPU 210 designates the selected virtual NAS to call the virtual NAS stopping program 572. Thereby, a virtual NAS stopping process is executed. This virtual NAS stopping process will be described later by referring to FIG. 15.

At step S203, the CPU 210 determines whether or not all the entries of the virtual NAS information table 800 have been checked. When determining that all the entries have not been checked (S203: NO), the CPU 210 repeats the processes of steps S201 and S202. On the other hand, when determining that all the entries have been checked (S203: YES), the CPU 210 completes this process.

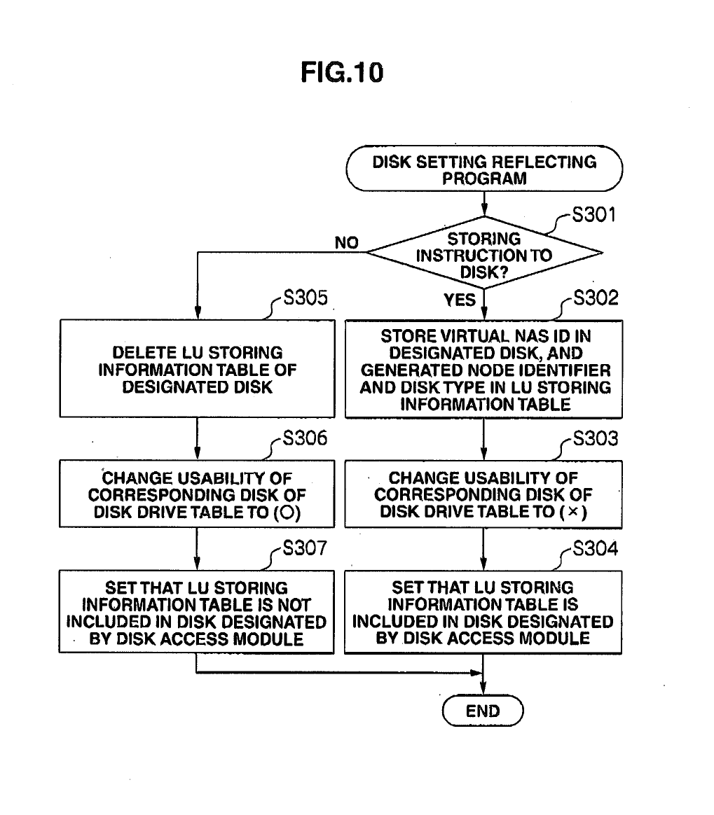

Next, the disk setting reflecting program 578 will be described. FIG. 10 is a flowchart illustrating a process when the CPU 210 executes the disk setting reflecting program 578.

At step S301, the CPU 210 determines whether or not the received data is a storing instruction to the disk. When determining that the received data is the storing instruction to the disk (S301: YES), at step S302, the CPU 210 stores the virtual NAS ID in the designated disk, and the generated identifier node, and information indicating the disk type in the LU storing information table 900. At step S303, the CPU 210 changes the usability of the corresponding disk of the disk drive table 700 to “X”. At step S304, the CPU 210 sets that the LU storing information table 900 is included in the disk designated by the disk access module 540. The CPU 210 completes the process.

On the other hand, when determining that the received data is not the storing instruction to the disk (S301: NO), at step S305, the CPU 210 deletes the LU storing information table 900 of the designated disk. At step S306, the CPU 210 changes the usability of the corresponding disk of the disk drive table 700 to “o”. At step S307, the CPU 210 sets that the LU storing information table 900 is not included in the disk designated by the disk access module 540. The CPU 210 completes the process.

Next, the disk setting analyzing program 577 will be described. FIG. 11 is a flowchart illustrating a process when the CPU 210 executes the disk setting analyzing program 577.

At step S401, the CPU 210 determines whether or not the LU storing information table 900 is included in the designated disk. When determining that the LU storing information table 900 is included (S401: YES), at step S402, the CPU 210 determines whether or not a row of the corresponding NAS is included in the virtual NAS information table 800. When determining that the row of the corresponding NAS is included (S402: YES), at step S403, the CPU 210 generates the row of the virtual NAS ID in the virtual NAS information table 800.

When determining that the row of the corresponding virtual NAS is not included (S402: NO), or when the row of the virtual NAS ID is generated at step S403, at step S404, the CPU 210 registers the disk identifier, the network port, the IP address, the condition, and the generated node identifier in the virtual NAS information table 800. At step S405, the CPU 210 generates the row of the corresponding disk of the disk drive table 700 to set the usability to “X”. The CPU 210 completes this process.

On the other hand, determining that the LU storing information table 900 is not included in the designated disk (S401: NO), at step S406, the CPU 210 generates the row of the corresponding disk of the disk drive table 700 to set the usability to “o”. The CPU 210 completes this process.

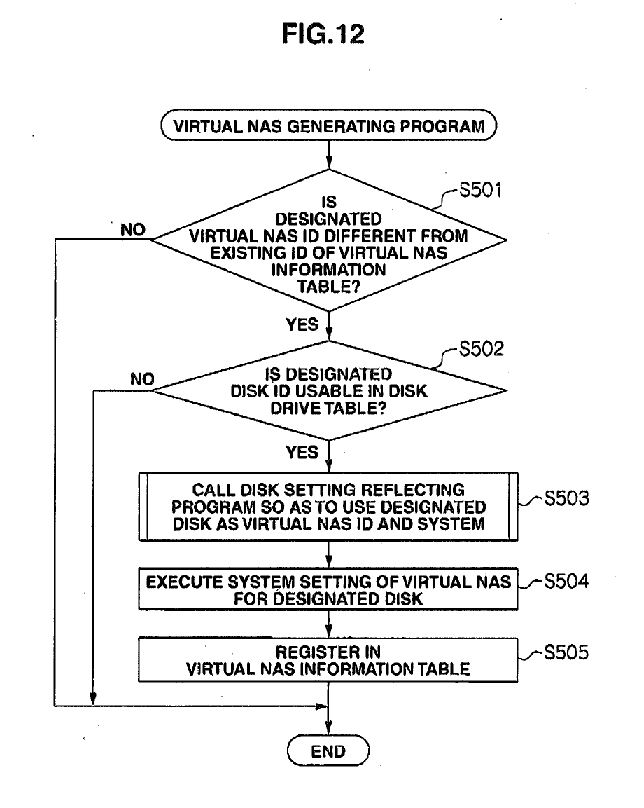

Next, the virtual NAS generating program 573 will be described. FIG. 12 is a flowchart illustrating a process when the CPU 210 executes the virtual NAS generating program 573.

At step S501, the CPU 210 determines whether or not the designated virtual NAS ID is different from the existing ID (identifier) of the virtual NAS information table 800. When determining that the designated virtual NAS ID is different (S501: YES), at step S502, the CPU 210 determines whether or not the designated disk ID can be utilized in the disk drive table 700.

When determining that the designated disk ID can be utilized (S502: YES), at step S503, the CPU 210 calls the disk setting reflecting program 578 so as to use the designated disk as the virtual NAS ID and the system. Thereby, the above disk setting reflecting process is executed. At step S504, the CPU 210 executes a system setting of the virtual NAS for the designated disk. At step S505, the CPU 210 registers information in the virtual NAS information table 800. The CPU 210 completes this process.

On the other hand, when determining that the designated virtual NAS ID is not different from the existing ID (identifier) (S501: NO), or when determining that the designated disk ID can not be utilized in the disk drive table 700 (S502: NO), the CPU 210 directly completes this process.

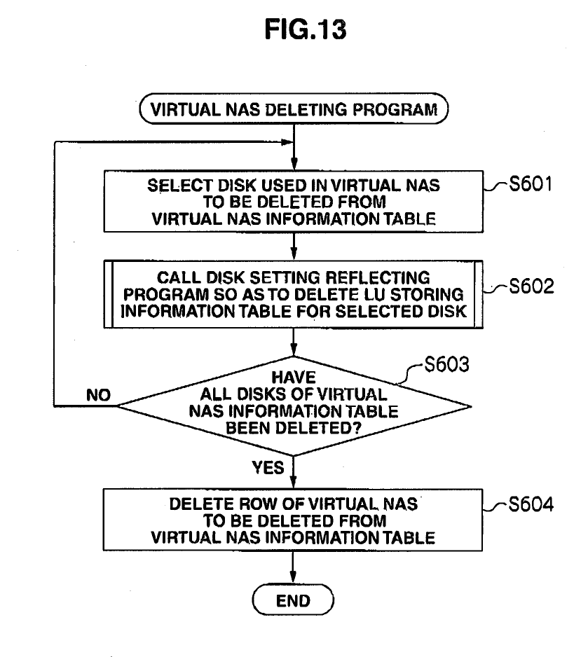

Next, the virtual NAS deleting program 574 will be described. FIG. 13 is a flowchart illustrating a process when the CPU 210 executes the virtual NAS deleting program 574.

At step S601, the CPU 210 selects the disk used for the virtual NAS to be deleted from the virtual NAS information table 800. At step S602, the CPU 210 calls the disk setting reflecting program 578 so as to delete the LU storing information table 900 for the selected disk. Thereby, the above disk setting reflecting process is executed.

At step S603, the CPU 210 determines whether or not all the disks of the virtual NAS information table 800 have been deleted. When determining that all the disks have not been deleted (S603: NO), the CPU 210 repeats the processes of steps S601 and S602. When determining that all the disks have been deleted (S603: YES), at step S604, the CPU 210 deletes the row of the virtual NAS to be deleted from the virtual NAS information table 800. The CPU 210 completes this process.

Next, the virtual NAS initiating program 571 will be described. FIG. 14 is a flowchart illustrating a process when the CPU 210 executes the virtual NAS initiating program 571.

At step S701, the CPU 210 reads the used disk information from the virtual NAS information table 800. At step S702, the CPU 210 determines based on the read used disk information whether or not the corresponding virtual NAS is stopped for all the cluster configuration nodes.

When determining that the corresponding virtual NAS is stopped (S702: YES), at step S703, the CPU 210 sets the virtual NAS ID and the used disk information in the virtual NAS executing module 530, and also, instructs the virtual NAS to be initiated. At step S704, the CPU 210 changes the condition of the virtual NAS information table 800 to “operating”.

As described above, when the process of step S704 is completed, or when determining that the corresponding virtual NAS is not stopped (S702: NO), The CPU 210 completes this process.

Next, the virtual NAS stopping program 572 will be described. FIG. 15 is a flowchart illustrating a process when the CPU 210 executes the virtual NAS stopping program 572.

At step S801, the CPU 210 instructs the virtual NAS executing module 530 to stop and cancel the setting. At step S802, the CPU 210 changes the condition of the virtual NAS information table 800 to “stopping”. The CPU 210 completes the process.

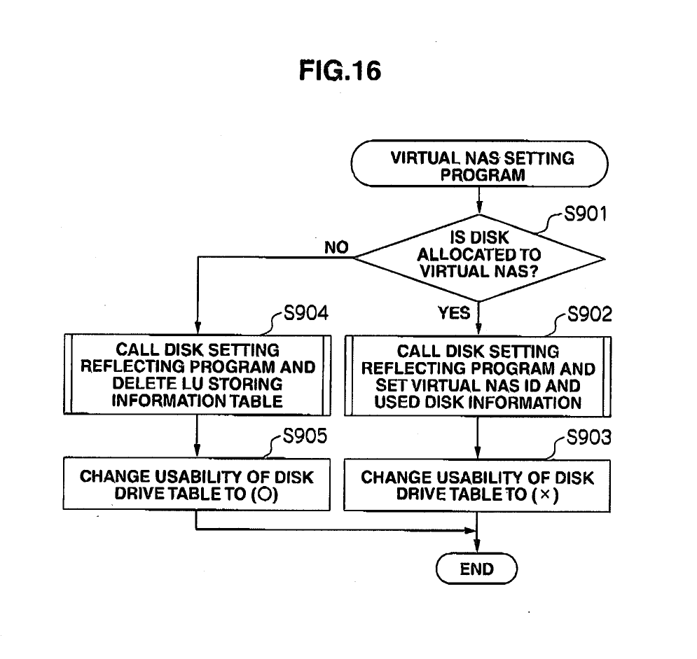

Next, the virtual NAS setting program 575 will be described. FIG. 16 is a flowchart illustrating a process when the CPU 210 executes the virtual NAS setting program 575.

At step S901, the CPU 210 determines whether or not the disk is allocated to the virtual NAS. When determining that the disk is allocated to the virtual NAS (S901: YES), at step S902, the CPU 210 calls the disk setting reflecting program 578 to set the virtual NAS ID and the used disk information. At step S903, the CPU 210 changes the usability of the disk drive table 700 to “X”.

On the other hand, when determining that the disk is not allocated to the virtual NAS (S901: NO), at step S904, the CPU 210 calls the disk setting reflecting program 578 to delete the LU storing information table 900. At step S905, the CPU 210 sets the usability of the disk drive table 700 to “O”. When completing the process of step S903 or S905, the CPU 210 completes this process.

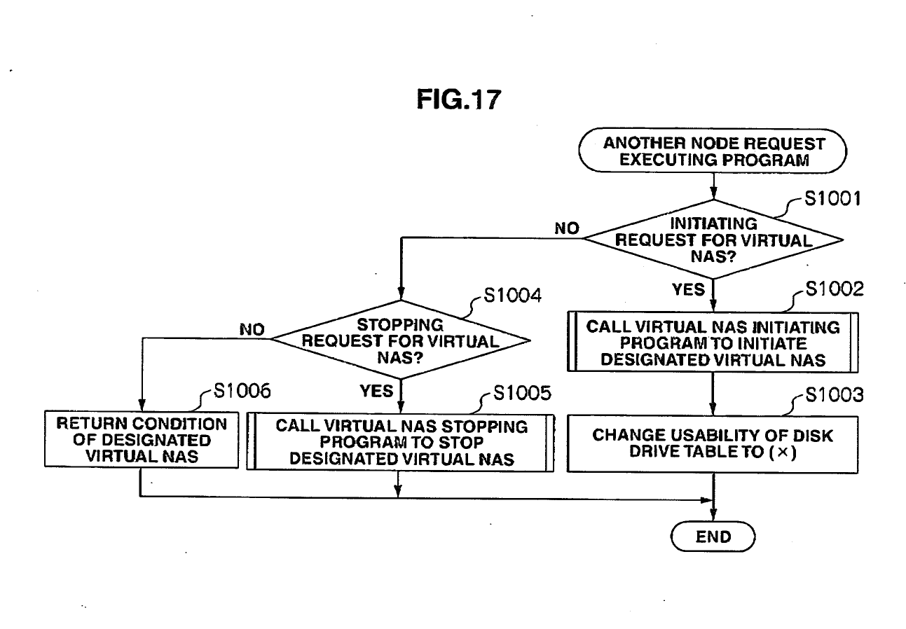

Next, the another node request executing program 581 will be described. FIG. 17 is a flowchart illustrating a process when the CPU 210 executes the another node request executing program 581.

At step S1001, the CPU 210 determines whether or not the received request is an initiating request for the virtual NAS. When determining that the received request is the initiating request for the virtual NAS (S1001: YES), at step S1002, the CPU 210 calls the virtual NAS initiating program 571 to initiate the designated virtual NAS. Thereby, the virtual NAS initiating process is executed. At step S1003, the CPU 210 sets the usability of the disk drive table 700 to “X”.

When determining that the received request is not the initiating request for the virtual NAS (S1001: NO), at step S1004, the CPU 210 determines whether or not the received request is a stopping request for the virtual NAS. When determining that the received request is the stopping request for the virtual NAS (S1004: YES), at step S1005, the CPU 210 calls the virtual NAS stopping program 572 to stop the designated virtual NAS. Thereby, a virtual NAS stopping process is executed.

When determining that the received request is not the stopping request for the virtual NAS (S1004: NO), at step S1006, the CPU 210 returns the condition of the designated virtual NAS. When the processes of steps S1003, S1005, and S1006 are completed, the CPU 210 completes this process.

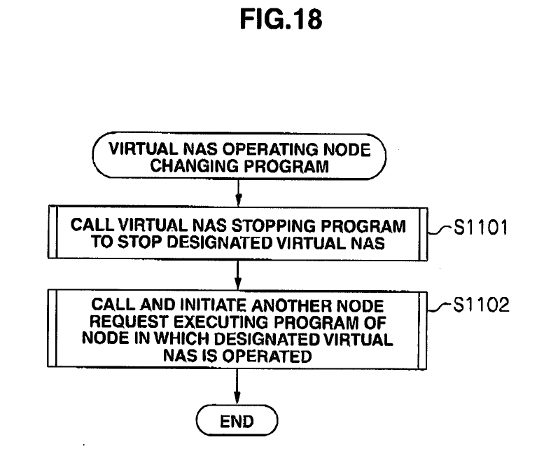

Next, the virtual NAS operating node changing program 576 will be described. FIG. 18 is a flowchart illustrating a process when the CPU 210 executes the virtual NAS operating node changing program 576.

At step S1101, the CPU 210 calls the virtual NAS stopping program 572 to stop the designated virtual NAS. At step S1102, the CPU 210 calls and initiates the another node request executing program 581 of the node in which the designated virtual NAS is operated. The CPU 210 completes this process.

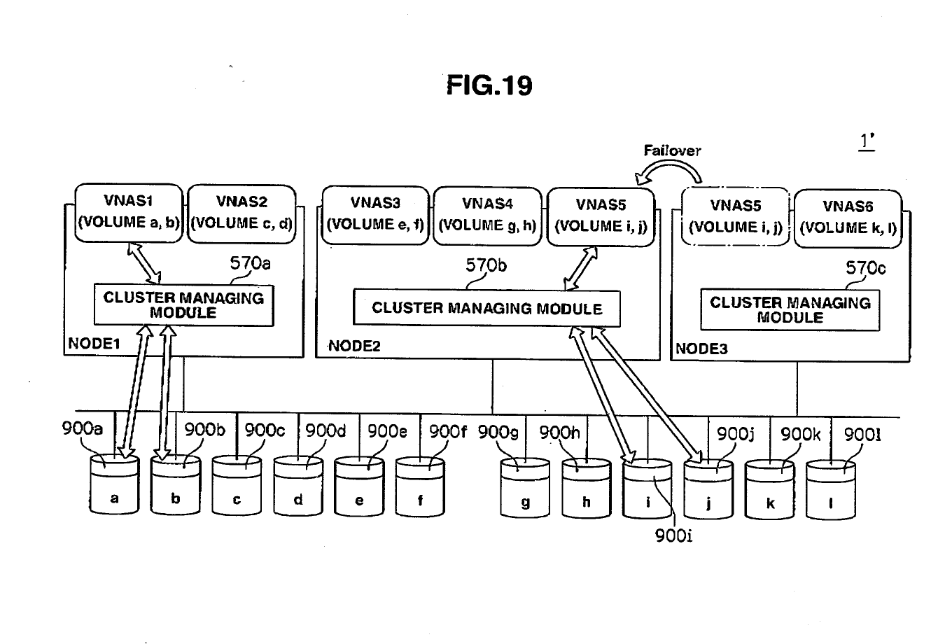

Next, Actions of the above-configured storage system 1 will be described. FIG. 19 is a diagram for describing the actions. Meanwhile, since such actions will be described by using one diagram that the volume is allocated to the virtual file server based on the LU storing information table 900, and that the volume is allocated to the virtual file server based on the LU storing information table 900 when changing the operating node, such a case will be described that the storage system 1 is designated as a storage system 1′.

FIG. 19 is a block diagram illustrating a logical configuration of the storage system 1′. The storage system 1′ includes a node 1 (NAS server) to node 3, and also, the volumes “a” to “l”. The node 1 includes a cluster managing module 570a, a virtual file server VNAS 1 (the volumes “a” and “b” are allocated), and a virtual file server VNAS 2 (the volumes “c” and “d” are allocated).

The node 2 includes a cluster managing module 570b, a virtual file server VNAS 3 (the volumes “e” and “f” are allocated), a virtual file server VNAS 4 (volumes “g” and “h” are allocated), and a virtual file server VNAS 5 (the volumes “l” and “j” are allocated).

The node 3 includes a cluster managing module 570c, and a virtual file server VNAS 6 (the volumes “k” and “l” are allocated). Meanwhile, the virtual file server VNAS 5 included by the node 2 is moved from the node 3 to the node 2 since the failover is executed for the virtual file server VNAS 5 of the node 3.

The volumes “a” to “l” include LU storing information tables 900a to 900l respectively. The virtual NAS identifier, which corresponds to the virtual file server in which each volume is utilized, is set in each of the LU storing information tables 900a to 900l. For example, “VNAS 1” is set as the virtual NAS identifier in the LU storing information tables 900a.

In the storage system 1′, the virtual file server VNAS 1 can write data and read data for the volumes “a” and “b” through the cluster managing module 570a. Even if the cluster managing module 570b tries to set the virtual NAS identifier, so that the volumes “a” and “b” can be utilized by the virtual file server VNAS 2, since “VNAS 1” is set as the virtual NAS identifier in the LU storing information tables 900a and 900lb, it is possible to confirm that the cluster managing module 570b can not utilize the volumes “a” and “b”. Thus, it is not necessary to share in all of the nodes 1 to the node 3 such information that the volumes “a” and “b” are utilized in the virtual file server VNAS 1.

Even when the failover is executed in the cluster managing module 570c, the virtual file server VNAS 5 is moved to the node 2, and the operating node of the virtual file server VNAS 5 is changed from the node 3 to the node 2, the generated node identifiers of the volumes “i” and “j” are changed from the identifiers corresponding to the node 3 to the identifiers corresponding to the node 2, by changing the generated node identifiers of the LU storing information tables 900i and 900j by executing the another node request executing program 581, so that it is not necessary to share the changed configuration information in all of the node 1 to the node 3.

As described above, in the storage system 1′, it is not necessary to synchronously process information on the configuration among the node 1 to the node 3 when the configuration of the volumes is changed, and it is possible to shorten a time for synchronously processing, and to reduce an amount of data to be stored.

### Second Embodiment

Next, a second embodiment will be described. Meanwhile, since a physical configuration of a storage system of the second embodiment is the same as that of the storage system 1, the same codes as those of the storage system 1 are attached to the configuration of the storage system, and the illustration and the description will be omitted.

The second embodiment is configured so that, when writing data to a volume and reading data from the volume, the CPU 410 determines whether or not the virtual NAS identifier of the request source corresponds to the virtual NAS identifier of the LU storing information tables 900 stored in the volume, and when both virtual NAS identifiers correspond to each other, the CPU 410 writes data or reads data.

Thus, in the storage system 1 of the second embodiment, it is not possible to write data or read data to or from the virtual file server whose virtual NAS identifier does not correspond to the virtual NAS identifier of the LU storing information tables 900 stored in the volume. That is, it is controlled so that another virtual file server operating on the same NAS server can not also access the volume. So that, the storage system 1 can be configured so as to hide a volume from the virtual file server other than the virtual file server corresponding to the volume. That is, it is possible to cause the virtual file server other than the virtual file server corresponding to the volume not to acknowledge the volume.

Meanwhile, while this second embodiment is configured so as to determine by using the virtual NAS identifier whether or not the virtual file server is the virtual file server corresponding to the volume, there are a plurality of methods for notifying the storage apparatus 400 of the virtual NAS identifier to determine the virtual NAS identifier of the request source. For example, when the connection between the virtual file server and the storage apparatus 400 is first defined, this connection is notified from the virtual file server to the storage apparatus 400, and the storage apparatus 400 stores the connection path. This is one method. Another method is as follows. The virtual NAS identifier is notified along with a command which is issued when the virtual file server writes data or reads data to or from the storage apparatus 400.

### Another Embodiment

Such a case is described in the first embodiment that the present invention is applied to such a configuration that the storage system 1 included in a cluster system includes a plurality of the volumes “a” to “h”, and a plurality of the virtual file servers VNAS 1 and VNAS 2 which utilize at least one or more volumes of the plurality of the volumes “a” to “h” for a data processing, each of the plurality of the virtual file servers VNAS 1 and VNAS 2 can access the plurality of the volumes “a” to “h,” and the volume, which is utilized by the plurality of the virtual file servers VNAS 1 and VNAS 2 for the data processing, includes the LU storing information table 900 for storing first identifiers (VNAS 1 and VNAS 2) indicating that the volume corresponds to the virtual file servers VNAS 1 and VNAS 2. However, the present invention is not limited to such a case.

Such a case is described that the present invention is applied to such a configuration that the storage system 1 includes the disk drive table 700 which maintains information indicating a condition whether or not each of the NAS servers 200 and 300 can utilize each of the plurality of the volumes “a” to “h”. However, the present invention is not limited to such a case.

In addition, such a case is described that the present invention is applied to such a configuration that the LU storing information table 900 includes second identifiers (NAS 1 and NAS 2). However, the present invention is not limited to such a case.

The present invention can be widely applied to the storage system and the volume managing method of the storage system.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A storage system included in a cluster system, comprising:
a plurality of volumes; and
a plurality of virtual servers utilizing at least one or more volumes of the plurality of volumes for a data processing,
wherein each of the plurality of virtual servers can access all of the plurality of volumes, and the volume utilized by the plurality of virtual servers for the data processing includes a storing unit for storing information indicating that the volume corresponds to the virtual server.

2. The storage system according to claim 1,
wherein the plurality of volumes are included in at least one or more storage apparatus, and the plurality of virtual servers are included in at least one or more servers.

3. The storage system according to claim 2,
wherein the data processing is a data write process or a data read process.

4. The storage system according to claim 3,
wherein each of the one or more servers includes a maintaining unit for maintaining information indicating a condition whether or not each of the plurality of volumes can be utilized.

5. The storage system according to claim 3,
wherein the volume is generated based on an instruction from a managing terminal for managing the storage system.

6. The storage system according to claim 3,
wherein the information stored in the storing unit includes information on a first identifier for specifying the virtual server corresponding to the volume in which the storing unit is stored.

7. The storage system according to claim 6,
wherein the information stored in the storing unit includes information on a second identifier for specifying the server including the virtual server specified by the first identifier.

8. The storage system according to claim 7,
wherein when a failover is executed for one of the plurality of virtual servers, and the one virtual server is changed so as to be included in another server, the second identifier stored in the storing unit is changed to the second identifier corresponding to the another server.

9. The storage system according to claim 6,
wherein the storage apparatus includes a controlling unit for executing controls for, when receiving a request for the data write process or the data read process from one of the plurality of virtual servers to one of plurality of volumes, determining whether or not the one of the plurality of virtual servers is the virtual server corresponding to the volume based on the information on the first identifier stored in the volume, when the virtual server from which the request is received is the corresponding virtual server, executing the data write process or the data read process, and when the virtual server from which the request is received is not the corresponding virtual server, not executing the data write process or the data read process.

10. A volume managing method for a storage system included in a cluster system, the storage system including a plurality of volumes and a plurality of virtual servers utilizing at least one or more volumes of the plurality of volumes for a data processing, comprising:
a step for storing information indicating that the volume corresponds to the virtual server in the volume utilized by the plurality of virtual servers for the data processing; and
a step for accessing based on the stored information when the plurality of virtual servers execute the data processing for one of the plurality of volumes.

11. The volume managing method for the storage system according to claim 10,
wherein the plurality of volumes are included in at least one or more storage apparatus, and the plurality of virtual servers are included in at least one or more servers.

12. The volume managing method for the storage system according to claim 11,
wherein the data processing is a data write process or a data read process.

13. The volume managing method for the storage system according to claim 12,
wherein each of the one or more servers includes
a step for maintaining information indicating a condition whether or not each of the plurality of volumes can be utilized.

14. The volume managing method for the storage system according to claim 12, comprising:
a step for generating the volume based on an instruction from a managing terminal for managing the storage system.

15. The volume managing method for the storage system according to claim 12,
wherein the information at the storing step includes information on a first identifier for specifying the virtual server corresponding to the stored volume.

16. The volume managing method for the storage system according to claim 15,
wherein the information at the storing step includes information on a second identifier for specifying the server including the virtual server specified by the first identifier.

17. The volume managing method for the storage system according to claim 16, comprising:
a step for changing the second identifier stored at the step for storing the second identifier to the second identifier corresponding to another server when a failover is executed for one of the plurality of virtual servers, and the one virtual server is changed so as to be included in the another server.

18. The volume managing method for the storage system according to claim 12, comprising:
a step for determining, when receiving a request for the data write process or the data read process from one of the plurality of virtual servers to one of the plurality of volumes, whether or not the virtual server from which the request is received is the virtual server corresponding to the volume based on the information on the first identifier stored in the volume;
a step for executing the data write process or the data read process when the virtual server from which the request is received is the corresponding virtual server; and
a step for not executing the data write process or the data read process when the virtual server from which the request is received is not the corresponding virtual server.
